(19) United States
(12) Patent Application Publication
(10) Pub. No.: US 2025/0025833 A1
(43) Pub. Date: Jan. 23, 2025

(54) INTEGRATED WATERBOARD FOR A WATER PURIFIER

(71) Applicant: Zhejiang Qinyuan Water Treatment S. T. Co., Ltd., Ningbo City (CN)

(72) Inventors: Xiangjie Guo; Li LIN, Ningbo City (CN); Huayuan ZENG

(73) Assignee: Zhejiang Qinyuan Water Treatment S. T. Co., Ltd., Ningbo City (CN)

(21) Appl. No.: 18/840,989

(22) PCT Filed: Feb. 23, 2023
(86) PCT No.: PCT/EP2023/054487

§ 371 Date: Aug. 23, 2024

(30) Foreign Application Priority Data
Feb. 24, 2022 (WO) PCT/CN2022/077769
Mar. 28, 2022 (EP) 22164824.9

(51) Int. Cl. B01D 61/08; B01D 61/02; B01D 61/04; C02F 1/00; C02F 1/28; C02F 1/44; C02F 9/00

(52) U.S. Cl. CPC B01D 61/08; B01D 61/025; B01D 61/04; C02F 9/00; B01D 2311/04; B01D 2311/06; B01D 2313/18; B01D 2313/243; C02F 1/001; C02F 1/283; C02F 1/441; C02F 2201/005

(57) ABSTRACT

The present invention relates to RO water purifiers. An object is to provide a simpler waterway as compared to prior art, that can be used in RO water purifiers. A further object is to provide an RO purifier comprising a waterway in which one or more components may be easily replaced. Disclosed is a reverse osmosis (RO) water purification device comprising an integrated waterway. The objects are met through the RO water purifier of the invention comprising a waterway which has pre-filter component, an RO component, and a post-filter component. The pre-and post-filter components each comprise pilot-operated solenoid valve having an electro-mechanical solenoid and a hydraulic part which is integrally molded with the component. The pre-filter component is removably connected with the post filter component and the post filter component is removably connected with the RO component via a removable connector. Each solenoid valve comprises a removable electro-mechanical solenoid and a non-removable hydraulic part which is integrally molded with the pre-filter component and said a post-filter component, respectively.

### FIELD OF THE INVENTION

This invention provides an advanced integrated waterway board system for a water purifier.

### BACKGROUND OF THE INVENTION

Reverse osmosis water purifiers are assembled with conventional waterways containing interconnected tubes, filters, and various control components, such as inlet water valve, waste-water valve, flowmeter, one-way valve, and high-pressure switch. There is need for water-tight leak proof connections and seals and sufficient space for each component inside the device.

Reverse osmosis devices are designed to work under high pressure to overcome the osmotic pressure.

Conventional RO devices have diversified filtration functions resulting in complex waterways, many water tubes and connectors and sizable filtration devices. A lot of time is needed to connect, seal, and test the joints.

Integrated waterways (also known as integrated waterboard) have been used in RO devices as an alternative to conventional waterways composed of pipes and fittings.

US2017043296 A1 (Xiamen Runner) discloses an integrated welded waterway structure of a reverse osmosis (RO) water filtration device includes a mounting base, a welded inlet plate assembly, a welded outlet plate assembly mounted on the mounting base through hot plate welding. Water to be filtered sequentially goes through a water inlet of the welded inlet plate assembly, a front cartridge inlet and a front cartridge outlet of a front cartridge, a water inlet and a water outlet of the pump, a RO water inlet of a RO filter cartridge through a RO water channel of the mounting base, a RO water outlet of the RO filter cartridge, a check valve and a flowmeter of the welded outlet plate assembly, a back cartridge inlet and a back cartridge outlet of a back cartridge, and a filtered water outlet of the welded outlet plate assembly to get the water filtered.

CN214243950 U (ZHONGSHAN YALESI WATER PURIFICATION TECHNOLOGY CO LTD) discloses a board body having integrally formed waterway panel in which the filter element needs to be fitted directly onto the interface integrally formed on the board body when assembling the filter element. This feature saves time and effort further helped by the reverse osmosis membrane filter element and the respective interface of the composite filter element being integrally formed with the board body.

CN111196641 A (FOUSHAN SHUNDE, 2020) discloses how water flows through different components, including pre-filter, RO and post-filter components. The solenoid is removable, and it works as part of the water way, not specifically as part of waterboard.

CN1105526430 A (FOSHAN YUNMI, 2019) discloses a water system, including a waterway and a filter element assembly. The waterway is modular spliced waterway, and the spliced waterway includes four modules and each module is a piece of a separate waterway board, and each module is equipped with a waterway pipeline.

The filter element assembly includes a pre-filter element, an RO filter element and a post-filter element, the first module and the second module are fixedly connected and clamped to fix the pre-filter element. This application discloses the use of standard solenoid valves.

However, the water purifiers containing integrated waterways of prior art are complex in their operation and assembly. Further, in case of failure or fault in any part of the waterway would necessitate complete replacement of the entire waterway. This invention provides an advanced integrated waterway board system (waterway), which can significantly reduce product size and assembly steps while still maintaining the control flexibility through effective combination of sub-components and control components.

It is an object of the invention to provide a simpler waterway, as compared to prior art, that can be used in RO water purifiers. A further object is to provide an RO purifier comprising a waterway in which one or more components may be easily replaced.

### SUMMARY OF THE INVENTION

The present invention provides an ingenious combination of waterway control components and filter connectors.

Disclosed is a reverse osmosis (RO) water purification device comprising an integrated waterway, a prefilter (PF), an RO membrane (M) and a post-filter (PoF) for purification of water, wherein

said integrated waterway comprises:
a) a pre-filter component (1) in fluid communication with said pre-filter (PF), where said component (1) comprises an input (1a) for tap water, a dispensing output (1b) for pure water, a flow out (1c) for reject water, an output (1d) for flow of said tap water into said prefilter and an input (1e) for flow back of pre-treated water from said pre-filter (PF), a pilot-operated solenoid valve (1f) having an electro-mechanical solenoid (1g) and a hydraulic part (1h) which is integrally molded with the pre-filter component (1);
b) an RO component (4) in fluid communication with said RO membrane (M); and,
c) a post-filter component (2) in fluid communication with said post-filter (PoF), where said component (2) comprises a post-filter pilot-operated solenoid valve (2g) having an electro-mechanical solenoid (2h) and a hydraulic part (2i) which is integrally molded with the post-filter component (2),

wherein said pre-filter component (1) is removably connected with said post filter component (2) and said post filter component (2) is removably connected with said RO component (4) via a removable connector (3), wherein each solenoid valve (1f/g, 2g) comprises a removable electro-mechanical solenoid and a non-removable hydraulic part which is integrally molded with the pre-filter component (1) and said a post-filter component (2), respectively.

### DETAILED DESCRIPTION OF THE INVENTION

The reverse osmosis (RO) water purifier of the invention comprises an integrated waterway.

The term integrated waterway means a structure comprised of the parts as mentioned and which adopts multiple water inlet elements, the pump, and multiple water outlet elements to form a complete filtration waterway structure.

The waterway comprises:
a) a pre-filter component (1) in fluid communication with said pre-filter (PF), where said component (1) comprises an input (1a) for tap water, a dispensing output (1b) for pure water, a flow out (1c) for reject water, an output (1d) for flow of said tap water into said prefilter and an input (1e) for flow back of pre-treated water from said pre-filter (PF), a pilot-operated solenoid valve (1f) having an electro-mechanical solenoid (1g) and a hydraulic part (1h) which is integrally molded with the pre-filter component (1);
b) an RO component (4) in fluid communication with said RO membrane (M); and,
c) a post-filter component (2) in fluid communication with said post-filter (PoF), where said component (2) comprises a post-filter pilot-operated solenoid valve (2g) having an electro-mechanical solenoid (2h) and a hydraulic part (2i) which is integrally molded with the post-filter component (2),

It is preferred that each component (1, 2, 3 and 4) is moulded. Further preferably each component (1, 2, 3 and 4) is made of plastic. The pre-filter component (1) is removably connected to the post-filter component (2) via leak-proof attachment means (2m, 2n) on the post-filter component (2) and reciprocal means on said pre-filter component (1). The attachment means serves as conduit for water. It is preferred that the leak-proof attaching means is a screw fitting means which works by inter-engagement of the means (2m and 2n) with corresponding means positioned on the pre-filter (1). An alternative is a snap-fitting means.

Primary function of the pre-filter is to remove dirt and particulate matter from the input water. Any material suitable for the function may be included in the pre-filter. Non-limiting examples include cloth filter. Pre-filter typically includes a carbon filter and a sediment filter to remove sediment and chlorine that could clog or damage the RO membrane. Pre-treatment via the pre-filter on the one hand improves the water purification result, and on the other hand also avoids damage to the reverse osmosis unit by particulate impurities etc., thereby increasing the service life of the reverse osmosis unit.

Function of the post-filter (2) is to polish or clean the purified water i.e., RO permeate water, before it gets dispensed for drinking. Post-filter typically includes a carbon filter. Preferably the post-filter component (2) comprises an outlet (2f) in fluid communication with said post-filter (PoF) and a flow back port (2e) for entry of post-filtered water.

The post filter component (2) is removably connected with the RO component (4) via a removable connector (3). It permits unidirectional flow of purified water and wastewater from RO component (4) to the post-filter component (2). RO membrane is a reverse osmosis membrane. Water permeates through RO membrane under pressure. The pore size of RO membranes is generally 0.0001 micron, and the size of bacteria is 5000 times the pore size. Therefore, only water molecules and some mineral ions can pass, whereas other impurities and heavy metal substances cannot pass through the RO membrane. Preferably the reverse osmosis membrane is spiral wound or hollow-fibre membrane, most preferably a spiral wound membrane. The membrane is preferably a cross-flow type membrane. In a preferred embodiment the membrane is a cross-flow reverse osmosis membrane. The material of construction of the reverse osmosis membrane preferably includes any commercially available standard material selected from polysulfone, polyvinylidene fluoride (PDVF) and cellulose acetate.

Preferably the RO component (4) comprises an output (4g) in fluid communication with said RO membrane (M), an inlet (4f) for purified water, an inlet (4e) for reject water from pre-filter component (1), and flow out ports (4m) and (4n) for purified water and reject water, respectively.

It is preferred that the device includes a water flow-path between the pre-filter component (1) to the RO component (4), the path comprising a diaphragm pump (P) to pressurize the pre-treated water. The function of the pump is to pressurize the water so that it is within the operating range of the RO membrane (M). Inside the RO component (4), the incoming raw water is divided into pure water and wastewater for output. This wastewater, high in salt content, is also referred to as reject water.

Due to the construction of the RO water purifier comprising the integrated waterway of the invention, the components (1, 2, 3, 4) are selectively replaceable by disengaging the connections and replacing or removing any component which, for example, is faulty or worn-out.

According to the invention, each solenoid valve (1f, 2g) comprises a removable electro-mechanical solenoid and a non-removable hydraulic part which is integrally molded with the pre-filter component (1) and said a post-filter component (2), respectively. Each solenoid valve (1f, 2g) is a pilot-operated solenoid valve. It is preferred that each said electro-mechanical solenoid comprises a coil-spring and a piston. Further preferably, in each said electro-mechanical solenoid, said coil-spring and said piston are operatively connected to a respective diaphragm in the respective hydraulic valve.

Preferably the purifier further comprises a control module and a high-pressure switch; the pump, the incoming water valve and the high-pressure switch are all connected to the control module; the high-pressure switch is configured for sensing a pressure signal in the pressurizable tank and transmitting to the control module; the control module controls the pump and incoming water valve to operably open and close based on the pressure signal received.

Intelligent control of the water purifier is realized by means of the control module, making the operation of the entire water purifier more convenient and rational. When the water purifier is connected to power and tap water, if the water pressure at high-tension switch is lower than the set value, the main control panel will turn on the inlet solenoid valve and diaphragm pump. The water flow is shown as indicated on the figure, the arrows indicated the direction of water flow. The main control panel turns off the solenoid valve (1f) and pump (P) once the water pressure reaches the set valve.

### FIGURES

### BRIEF DESCRIPTION OF THE FIGURES

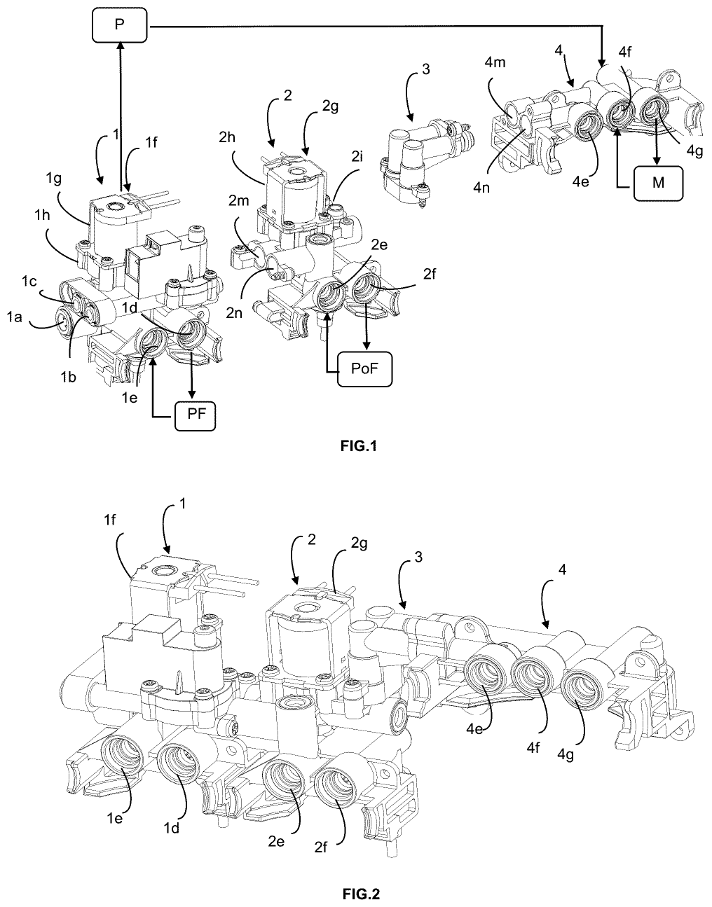

FIG. 1 is an exploded view of the integrated waterway, also showing the pre-filter, post-filter and the membrane.

FIG. 2 shows the same waterway in an assembled form viewed from another angle but without the pre-filter, post-filter and the membrane.

### DETAILED DESCRIPTION OF THE FIGURES

FIG. 1 is an exploded view of the integrated waterway also showing the pre-filter, post-filter and the membrane in block form.

The device comprises an integrated waterway, a prefilter (PF), an RO membrane (M) and a post-filter (PoF) for purification of water. The integrated waterway is made up of four components.

There is a moulded pre-filter component (1) in fluid communication with a pre-filter (PF). The fluid communication path has been shown with the help of arrows, the arrow heads indicating the direction of flow of water. The component (1) comprises an input (1a) for tap water, a dispensing output (1b) for pure water, a flow out (1c) for reject water. All three features are present at one side of the component (1). There is an output (1d) for flow of the tap water into the prefilter and an input (1e) for flow back of pre-treated water from said pre-filter (PF). The water gets pre-filtered inside the pre-filter.

There is a pilot-operated solenoid valve (1f) having an electro-mechanical solenoid (1) and a hydraulic part (1h). This hydraulic part is integrally molded with the pre-filter component (1). The hydraulic part is not separable from the pre-filter component (1). The electro-mechanical solenoid (1g) is connected to the hydraulic part (1h) by way of screws. The device also has a water flow-path between the pre-filter component (1) to the RO component (4), the path comprising a diaphragm pump (P) to pressurize the pre-treated water. The water-flow path enters into the RO component (4) at a point which is not visible in this view.

The device has a moulded RO component (4) in fluid communication with the RO membrane (M). The fluid communication path has been shown with the help of arrows, the arrow heads indicating the direction of flow of water. The post filter component (2) is removably connected with said RO component (4) via the removable connector (3). The connector is also a moulded component.

The post-filter moulded component (2) is in fluid communication with the post-filter (PoF). The fluid communication path has been shown with the help of arrows, the arrow heads indicating the direction of flow of water. The component (2) has a post-filter pilot-operated solenoid valve (2g) having an electro-mechanical solenoid (2h) and a hydraulic part (2i) which is integrally molded with the post-filter component (2).

The pre-filter component (1) is removably connected with the post filter component (2) and the post filter component (2) is removably connected with the RO component (4) via the removable connector (3).

The connector permits unidirectional flow of purified water and reject water from RO component (4) to the post-filter component (2).

Due to the removable connections between all the components, any of said components (1, 2, 3, 4) is selectively removable and replaceable.

FIG. 2 shows the same waterway in an assembled form viewed from another angle.

FIG. 3 shows a block diagram explaining the constructional features of the reverse osmosis (RO) water purifier comprising an integrated waterway of the invention.

The operating principles of the water purification system of the present invention are explained in conjunction with FIG. 1.

Tap water enters the pre-filter component (1) from input (1a) for tap water then flows out through the output (1d) into the prefilter (PF). Here it gets prefiltered and the prefiltered water flow back into component (1) through input (1e) for flow back of pre-treated water. Thereupon, via internal channel, the prefiltered water passes through pilot-operated solenoid valve (1f) and therethrough the pump (P) via pipe connection (shown as lines). The pressurized water then flows through the pipe along the direction of the line into the RO component (4). The RO component (4) has an output (4g) in fluid communication with the RO membrane (M). The water gets purified inside the RO membrane. Purified water flows back via inlet (4f) and reject water is sent to component (4) via inlet part (4e). The component (4) has flow out ports (4m) and (4n) for purified water and reject water, respectively. The purified and reject water then pass though the connector (3) and therethrough to the post-filter component (2).

The reject water then passes through the solenoid valve (2g) and thereon to part labelled (2m) into the pre-filter component (1).

The pure water is made to flow out of outlet into the post-filter (PoF) and back via a flow back port (2e) for entry of post-filtered water into the post-filter (2).

The reject water then passes to part labelled (2n) into the pre-filter component (1).

Once the post-filtered water and reject water is inside the pre-filter component (1), the post filtered pure water flows out via dispensing output (1b) and reject water flows out via flow out (1c).

1. A reverse osmosis (RO) water purification device comprising an integrated waterway, a prefilter (PF), an RO membrane (M) and a post-filter (PoF) for purification of water,
wherein said integrated waterway comprises:
a) a pre-filter component (1) in fluid communication with said pre-filter (PF), where said component (1) comprises an input (1a) for tap water, a dispensing output (1b) for pure water, a flow out (1c) for reject water, an output (1d) for flow of said tap water into said prefilter and an input (1e) for flow back of pre-treated water from said pre-filter (PF), a pilot-operated solenoid valve (1f) having an electro-mechanical solenoid (1g) and a hydraulic part (1h) which is integrally molded with the pre-filter component (1);
b) an RO component (4) in fluid communication with said RO membrane (M); and,
c) a post-filter component (2) in fluid communication with said post-filter (PoF), where said component (2) comprises a post-filter pilot-operated solenoid valve (2g) having an electro-mechanical solenoid (2h) and a hydraulic part (2i) which is integrally molded with the post-filter component (2),
wherein said pre-filter component (1) is removably connected with said post filter component (2) and said post filter component (2) is removably connected with said RO component (4) via a removable connector (3), wherein each solenoid valve (1f, 2g) comprises a removable electro-mechanical solenoid and a non-removable hydraulic part which is integrally molded with the pre-filter component (1) and said a post-filter component (2), respectively.

2. The device as claimed in claim 1 wherein the pre-filter component (1) is removably connected to the post-filter component (2) via leak-proof attachment means (2m, 2n) on said post-filter component (2) and reciprocal means on said pre-filter component (1).

3. The device as claimed in claims 1 comprising a water flow-path between said pre-filter component (1) to the RO component (4), said path comprising a diaphragm pump (P) to pressurize the pre-treated water.

4. The device as claimed in claim 1 wherein said connector (3) permits unidirectional flow of purified water and wastewater from RO component (4) to the post-filter component (2).

5. The device as claimed in claim 1 wherein said RO component (4) comprises an output (4g) in fluid communication with said RO membrane (M), an inlet (4f) for purified water, an inlet (4e) for reject water from membrane (M), and flow out ports (4m) and (4n) for purified water and reject water, respectively.

6. The device as claimed in claim 1 wherein said post-filter component (2) comprises an outlet (2f) in fluid communication with said post-filter (PoF) and a flow back port (2e) for entry of post-filtered water.
